(19) United States
(12) Patent Application Publication
(10) Pub. No.: US 2016/0241736 A1
(43) Pub. Date: Aug. 18, 2016

(54) SYSTEMS AND METHODS TO SPECIFY DESTINATIONS FOR DOCUMENTS FROM DIFFERENT SOURCES

(71) Applicant: Xerox Corporation, Norwalk, CT (US)

(72) Inventors: Veena Kumari Saluja, Welwyn Garden City (GB); David Berke, London (GB); Philip James Hambridge, Potters Bar (GB); Colin William Robert Hewitt, Letchworth Garden City (GB); Timothy David Jonathan Spink, Welwyn (GB); Lakshmi Sujatha Yaramsetti, Hatfield (GB)

(21) Appl. No.: 14/622,109

(22) Filed: Feb. 13, 2015

(51) Int. Cl. H04N 1/32; H04N 1/00; H04L 12/58

(52) U.S. Cl. CPC H04N 1/32069; H04L 51/08; H04L 51/10; H04N 1/00209; H04N 1/00411; H04N 1/00474; H04N 1/00965; H04N 1/0097; H04N 2201/0094; H04N 2201/3208; H04N 2201/3209; H04N 2201/0096

(57) ABSTRACT

Systems and methods for a multifunction device, a control system has a processor in data communication with a memory. A local user interface is connected to the control system. A portable data storage device is connected to a port. The local user interface provides user selection of one of mutually exclusive document delivery workflow operations under control of the control system. The local user interface provides user selection of a source for a document recipient's address according to one of the document delivery workflows. Upon selection of the source for the document recipient's address being the portable data storage device, the processor scans the portable data storage device and displays files containing addresses on the local user interface. The local user interface receives selection of designated recipient's address according to the selected document delivery workflow. The processor saves each the designated recipient's addresses in the memory.

### BACKGROUND

Systems and methods herein generally relate to machines such as printers and/or fax devices and, more particularly, to management of destinations for documents from different sources.

Many multi-function devices include the ability to scan and send documents to recipients. For example, for a system to scan a document to email, customers manually add their email addresses to the local address book of a particular device used to send a document. For a system to scan a document for fax transmission, customers manually input the recipient's number to a particular device used to send a document. This process is tedious for manual input of a large destination recipient list. Furthermore, the process is prone to errors. The email address or fax number may be added either at the machine or through a Network Control system, but this requires network connectivity/access.

For the selected workflows for either email or fax, the destinations (email address/phone numbers) need to be specified prior to pressing the Start button for the Job. Typically, the user can specify the destination by typing it using the soft keyboard on the local user interface (LUI). Currently, when the destinations are available either on a hard copy document (telephone book) or as soft copy on a portable data storage device, such as a USB memory stick and the like, there is no way to use them as input for the job. In addition, there is no mechanism to support destinations from two different sources to be used as input for the job.

### SUMMARY

One aspect of a method disclosed herein is about giving the user the ability to specify inputs for destination addresses (email address/phone numbers) on different sources, i.e., USB or hard copy documents, in addition to soft keyboard, for workflows that require destination addresses. In case of hard copy, the user scans the document containing destination list using an automatic document handler, scanner, or platen. For recipient addresses stored on a USB device or electronic device in a file, the multi-function device scans the USB and identifies potential destination addresses. For example, the recipient details for an email workflow would be in the form of email addresses and in the case of a fax workflow, the recipient details would be in the form of phone numbers. This eliminates the need to manually type the destinations available on hard copy or stored on USB. It allows user to use input from different sources for the same job.

Another aspect is about providing the ability to sequentially insert more than one USB device containing addresses/fax numbers or scan additional hard copy document in order to append these sub entries found to create one list for transmission.

According to a method herein, a document for transmission is obtained. A selection of the transmission being by fax or email is received. Selection of a source for a recipient's address is prompted. The source may be a hard copy document, a portable data storage device, a local address book, or manual entry. The recipient's address may be a fax number or email address. Upon selection of the source being the portable data storage device, the portable data storage device is scanned. One or more files containing addresses is displayed. Selection of designated addresses for the transmission is received. The document is transmitted to the designated addresses.

According to another method herein, a portable data storage device is received into a document rendering device. The portable data storage device comprises at least one electronic document containing an address list. The portable data storage device is scanned and addresses found on the portable data storage device are displayed. Selection of addresses for transmission of a document is received. A destination list is created comprising addresses selected for transmission. The document is transmitted to addresses on the destination list.

According to a multifunction device, a control system comprises at least one processor in data communication with a memory. A local user interface is connected to the control system. The device includes a port. A portable data storage device is connected to the port. The local user interface provides user selection of a selected one of mutually exclusive operations under control of the control system. The mutually exclusive operations comprise document delivery workflows. The local user interface provides user selection of a source for a document recipient's address according to one of the document delivery workflows. Upon selection of the source for the document recipient's address being the portable data storage device, the processor scans the portable data storage device and displays files containing addresses on the local user interface under control of the control system. The local user interface receives selection of designated recipient's address according to the one of the document delivery workflows. The processor saves each the designated recipient's address in the memory.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a network according to systems and methods herein;

FIG. 2 is a side-view schematic diagram of a multi-function device according to systems and methods herein; and

FIGS. 3A and 3B are flow diagrams illustrating methods herein; and

FIG. 4 is a schematic diagram illustrating systems and methods herein.

### DETAILED DESCRIPTION

For a general understanding of the features of the disclosure, reference is made to the drawings. In the drawings, like reference numerals have been used throughout to identify identical elements. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

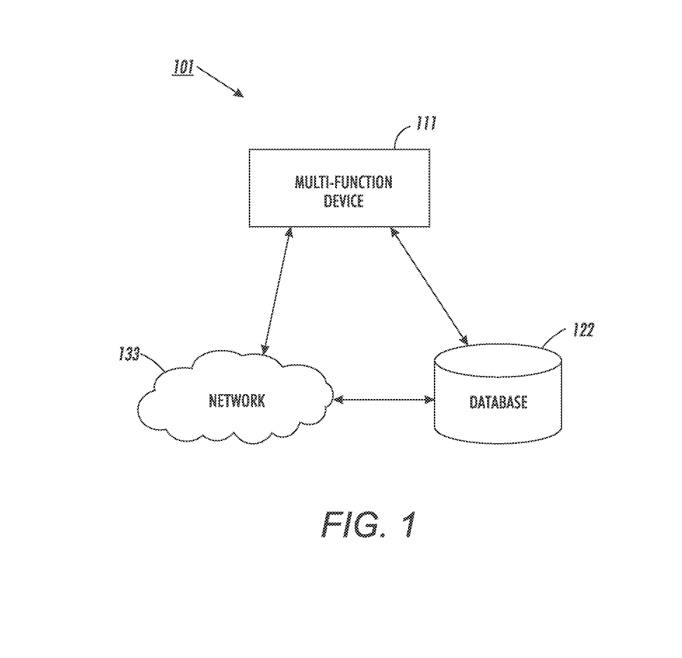

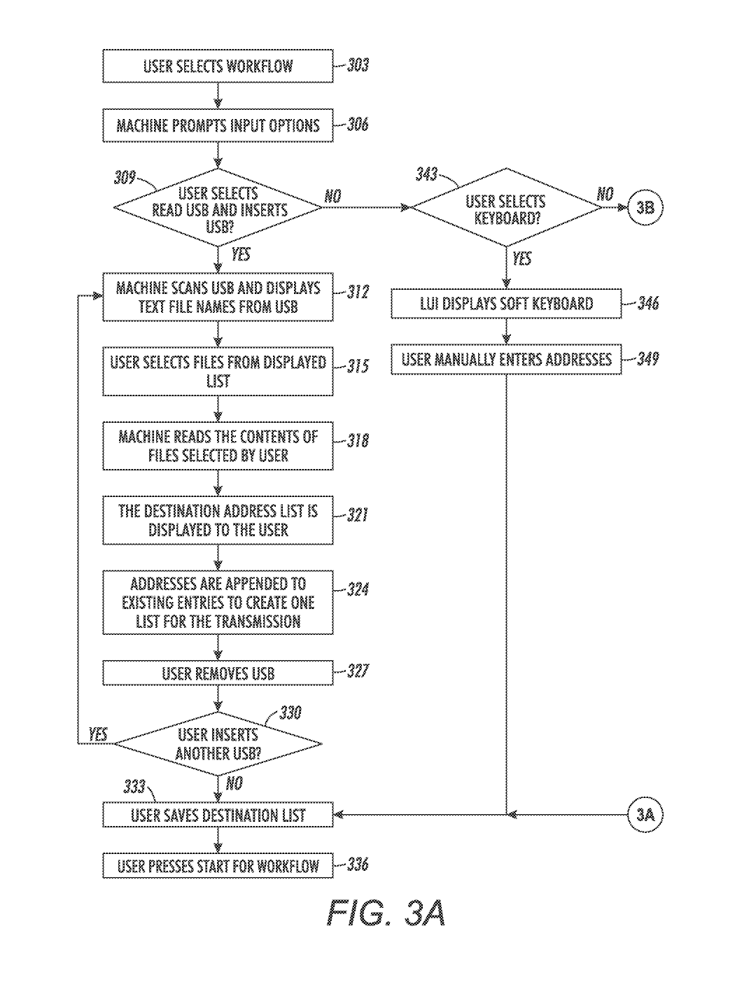

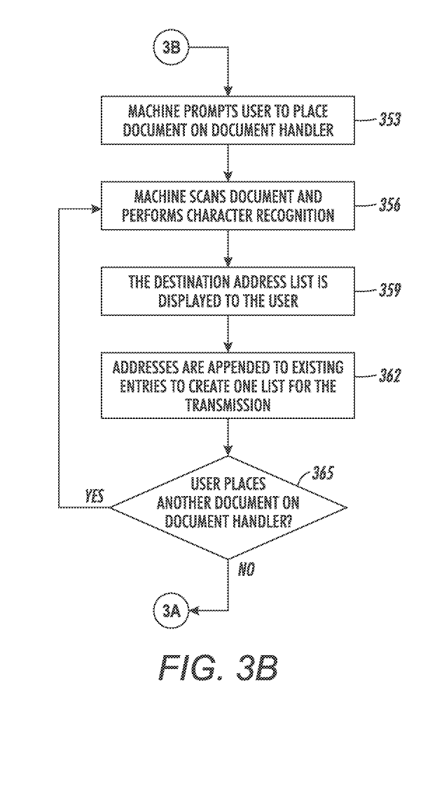

Referring now to the drawings, FIG. 1 is a general overview block diagram of a network, indicated generally as 101, for communication between a multi-function device 111 and a database 122. The multi-function device 111 may comprise any form of processor as described in further detail below. The multi-function device 111 can be programmed with appropriate application software to implement the methods described herein. Alternatively, the multi-function device 111 is a special purpose machine that is specialized for processing document transmission and includes a dedicated processor that would not operate like a general purpose processor because the dedicated processor has application specific integrated circuits (ASICs) that are specialized for the handling of document processing operations, processing transmission data, identifying address strings, etc. In one example, the multi-function device 111 is special purpose machine that includes a specialized processor card having unique ASICs for providing character recognition processing, includes specialized boards having unique ASICs for input and output devices to speed network communications processing, a specialized ASIC processor that performs the logic of the methods described herein (such as the processing shown in FIGS. 3A and 3B) using dedicated unique hardware logic circuits, etc.

Database 122 includes any database or any set of records or data that the multi-function device 111 desires to retrieve. In some cases, database 122 may comprise a portable data storage device. Database 122 may be any organized collection of data operating with any type of database management system. The database 122 may contain matrices of datasets comprising multi-relational data elements.

The database 122 may communicate with the multi-function device 111 directly. Alternatively, the database 122 may communicate with the multi-function device 111 over network 133. The network 133 comprises a communication network either internal or external, for affecting communication between the multi-function device 111 and the database 122. For example, network 133 may comprise a local area network (LAN) or a global computer network, such as the Internet.

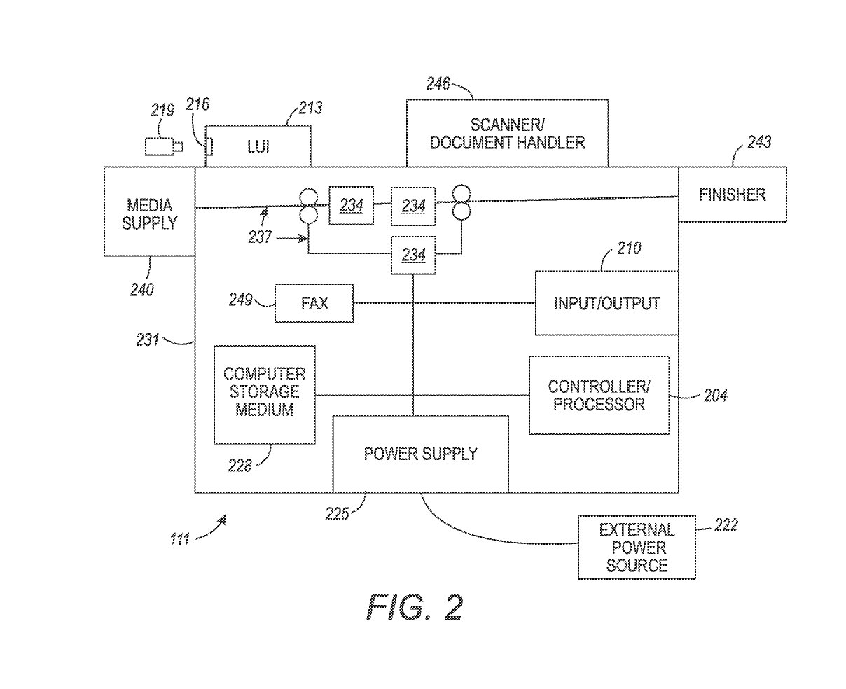

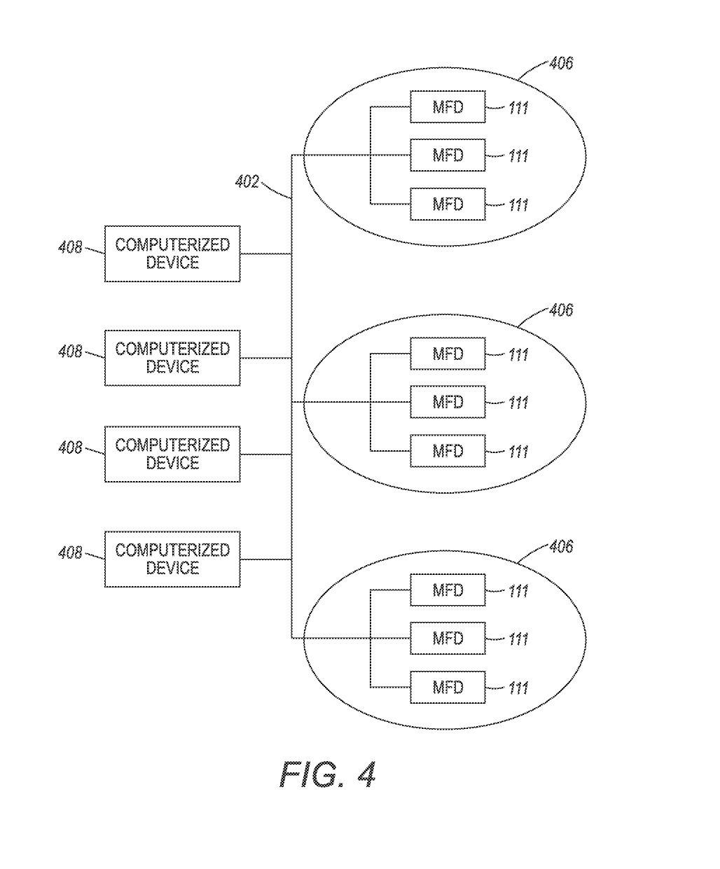

FIG. 2 illustrates a multi-function device 111 that can be used with systems and methods herein and can comprise, for example, a printer, copier, fax machine, etc. The multi-function device 111 includes a controller/processor 204 and an input/output device 210 operatively connected to the controller/processor 204. As described above, the controller/processor 204 may be connected and to a computerized network 402 external to the multi-function device 111 through a communications port of the input/output device 210, such as shown in FIG. 4. In addition, the multi-function device 111 can include at least one accessory functional component, such as a local user interface assembly (LUI) 213. The LUI 213 may include a port 216 having a connection for a portable data storage device 219, such as a universal serial bus (USB) port. The LUI 213 operates on power supplied from an external power source 222. The external power source 222 may provide electrical power through the power supply 225.

The input/output device 210 is used for communications to and from the multi-function device 111. The controller/processor 204 controls the various actions of the multi-function device 111. A non-transitory computer storage medium 228 (which can be optical, magnetic, capacitor based, etc.) is readable by the controller/processor 204 and stores instructions that the controller/processor 204 executes to allow the multi-function device 111 to perform its various functions, such as those described herein. Thus, as shown in FIG. 2, a device housing 231 has one or more functional components that operate on power supplied from the external power source 222, which may comprise an alternating current (AC) power source, through the power supply 225. The power supply 225 can comprise a power storage element (e.g., a battery) and connects to the external power source 222. The power supply 225 converts the external power into the type of power needed by the various components of the multi-function device 111.

The multi-function device 111 may include at least one marking device 234 (sometimes referred to as printing engines) operatively connected to the controller/processor 204, a media path 237 positioned to supply sheets of media from a media supply 240 to the marking device(s) 234, etc. along the media path 237. After receiving various markings from the printing engine(s), the sheets of media can optionally pass to a finisher 243 which can fold, staple, sort, etc., the various printed sheets. In addition, the multi-function device 111 can include at least one accessory functional component (such as a scanner/document handler 246, fax module 249, etc.) that also operates on the power supplied from the external power source 222 (through the power supply 225). The fax module 249 may operate in conjunction with the scanner/document handler 246 in order to transmit a selected document according to systems and methods herein.

The scanner/document handler 246 may be any image input device capable of obtaining information from an image. The set of image input devices is intended to encompass a wide variety of devices such as, for example, digital document devices, computer systems, memory and storage devices, networked platforms such as servers and client devices which can obtain pixel values from a source device, and image capture devices. The set of image capture devices includes scanners, cameras, photography equipment, facsimile machines, photo reproduction equipment, digital printing presses, xerographic devices, and the like. A scanner is one image capture device that optically scans images, print media, and the like, and converts the scanned image into a digitized format. Common scanning devices include variations of the flatbed scanner, generally known in the art, wherein specialized image receptors move beneath a platen and scan the media placed on the platen. Modern digital scanners typically incorporate a charge-coupled device (CCD) or a contact image sensor (CIS) as the image sensing receptor(s). The scanning device produces a signal of the scanned image data. Such a digital signal contains information about pixels such as color value, intensity, and their location within the scanned image.

As would be understood by those ordinarily skilled in the art, the multi-function device 111 shown in FIG. 2 is only one example and the systems and methods herein are equally applicable to other types of printing devices that may include fewer components or more components. For example, while a limited number of printing engines and paper paths are illustrated in FIG. 2, those ordinarily skilled in the art would understand that many more paper paths and additional printing engines could be included within any printing device used with systems and methods herein.

According to devices and methods herein, whenever a user needs to use Scan2Email/Fax Send workflows on a multi-function device 111, they would be presented with a list of sources and requested to select one or more of them to be used as the input sources for destinations. The available address input options may include a soft keyboard on the local user interface (LUI) 213, a portable data storage device 219, such as a USB memory stick, or a hard copy document. For example, a special icon may be provided on the LUI 213 (Destinations For Scan2Email/Fax), which, upon selection, would provide the user with the various options: Soft Keyboard on LUI, USB, hard copy, etc.

Referring to FIGS. 3A and 3B, an exemplary method is illustrated. According to devices and methods herein, actions by the user may be accomplished at a machine, such as the multi-function device 111 using the local user interface (LUI) 213. At 303, the user selects a workflow. The workflow may be for sending a document by email or for sending a document by fax. The workflow indicates the type of address to use, i.e. fax number or email address. At 306, the machine displays different options for providing a list of designated recipient's and prompts the user to select one. According to devices and methods herein, the multi-function device 111 may have an address book and/or allow the user to enter the email address/phone number of a recipient.

USB: On selection of the Read USB option, at 309, the user inserts a portable data storage device 219, such as a USB memory stick into a port 216 on the multi-function device 111. The machine scans the USB, at 312, and displays file names for text files found on the USB device. At 315, the user selects the file or files from the list of text files to be used as a destination list. At 318, the machine reads the contents of files selected by user. The machine builds the address list, and any duplicated addresses are eliminated from the final list of recipients. The destination list of addresses from the USB files is displayed to the user, at 321. At this point, the user may optionally modify the destination list i.e., remove or add any more designated addresses to the list and edit characters within individual entries. At 324, any additional addresses are appended to existing entries to create one list for the transmission. The user removes the USB, at 327 and, if necessary, at 330, inserts another portable memory device, such as a second USB memory stick into the USB port on the multi-function device 111. At 333, once the selection of designated addresses for the transmission is complete, the user can save the destination list to the computer storage medium 228. The user, at 336, then presses a start button for the selected workflow.

Soft Keyboard on LUI: On selection of the Keyboard option, at 343, the soft keyboard is displayed on the LUI 213, at 346. At 349, the user enters email addresses or phone numbers depending on the selected workflow. The user may modify an existing address book to create the destination list. Once the selection of designated addresses for the transmission is complete, at 333, the user can save the destination list to the computer storage medium 228. The user then presses the start button for the selected workflow, at 336.

Hard Copy: On selection of the Hard Copy option, at 353 (FIG. 3B), the user is prompted to place the document having a destination list on the scanner/document handler 246. The machine scans the hard copy of the document, at 356, and performs character recognition on the document to detect address information, such as email addresses or phone number, on the hard copy sheet placed on the scanner/document handler 246. Email addresses may be recognized by the detection of a ‘@’ character found within a text string. Fax phone numbers may be recognized by the detection of a series of numerals within the text string. After the sheet is scanned, the destination list from the scanned copy is displayed to the user, at 359. Again, the user may have the option to modify the list i.e., remove or add any designated addresses to the list and edit characters within individual entries. At 362, any additional addresses are appended to existing entries to create one list for the transmission. If necessary, at 365, the user places another document having a destination list on the scanner/document handler 246. At 333 (FIG. 3A), once the selection of designated addresses for the transmission is complete, the user can save the destination list of designated addresses to the computer storage medium 213. The user, at 336, then presses a start button for the selected workflow.

It is contemplated that the selected document delivery workflows (email workflow and fax workflow) are mutually exclusive; however, devices and methods herein contemplate allowing the user to specify destinations from multiple sources, such as any combination of USB, soft keyboard, or hard copy scan, as described above. No manual entry is required to transfer destinations from USB/hardcopy for job submission. Such removal of manual entry results in saving on time. The process described herein may be particularly useful for users with variable recipient lists, requiring large manual data that is input on the LUI or configured on network.

As would be know by one of ordinary skill in the art, a USB memory stick is a lightweight portable device. A user can easily copy addresses from any device to a USB for the Scan2Email/Fax Send workflow. Furthermore, maintaining the address list on a USB restricts the availability of addresses to others users who do not need it. Data for this method is therefore secure.

The process described herein supports text files in plain or formatted data on the USB and leverages existing workflow. As would be known by one of ordinary skill in the art, the files that store the address data need to have a mechanism that helps identify the end of an address. Such mechanism can be a semi-colon, by default; however, in order to provide flexibility, the delineator can be any appropriate character (for example, a comma, colon, dash, etc.) that has been set by the System Administrator/Key Operator (SAKO) and stored in a non-volatile memory. The files may be searched based on what has been stored on the machine for an address delimiter in non-volatile memory. For example, in the case of a Scan2Email workflow, recipient details may include email addresses separated by semi-colon in a text file. In the case of a Fax Send workflow, recipient details include phone numbers, which may be separated by a semi-colon in a text file. As noted above, the address delimiters can be SAKO settable.

In the current method, the multi-function device 111 may have an address book and/or allow the user to enter the email address/phone number of a recipient. For devices that maintain an address book, users typically have to add their email address/phone number to the address book either at the device or through software networked to the device. The USB method does not require machine to be on the LAN or WI-FI or blue tooth to provide recipient list.

According to devices and methods herein, the multi-function device (MFD) 111 prompts users if they want to save the address list from USB to the MFD for future use, add it an existing address book, or create a group.

In other words, the process described herein describes methods of acquiring destination addresses (fax numbers or email addresses) to which to send scanned document image(s). In one of the methods, a paper document is scanned and destination addresses are extracted from the image through character recognition and parsing of the text data. In another method, a USB or other removable electronic media is scanned for documents containing text data. The text data is parsed for destination addresses. Once a list of potential destination addresses is determined, the user can select a sub-set of them for use with the current job. In cases where errors are introduced by the methods above, the user can modify the destination list (i.e. remove, add, or edit characters within entries).

It is contemplated that the processes occur automatically depending on the selected workflow and the source of addresses. For example, in the case of selecting a portable data storage device as the input method for the source of addresses, the operating system of the MFD detects the device and automatically scans it. Copy Control Software (CCS) retrieves a list of file names of electronic documents on the portable data storage device, filters the file list based on file formats, and sends a list of only text files to display on the LUI, using a Remote Procedure Call (RPC) API. The user selection of particular files is sent from the LUI to the CCS, using the RPC API. The CCS reads the contents of the particular files, parses the list, and removes any duplicate entries, creating an updated list. The CCS stores the updated list in a container. The updated list is sent to the LUI where the user can modify or save the list. If the list is modified on the LUI, the modified list is sent back to the CCS to update the container storing the recipient list.

As shown in FIG. 4, exemplary printers, copiers, fax machines, and multi-function devices (MFD) 111 may be located at various different physical locations 406. Other devices according to systems and methods herein may include various computerized devices 408. The computerized devices 408 can include print servers, printing devices, personal computers, etc., and are in communication (operatively connected to one another) by way of a network 402. The network 402 may be any type of network, including a local area network (LAN), a wide area network (WAN), or a global computer network, such as the Internet.

The hardware described herein plays a significant part in permitting the foregoing method to be performed, rather than function solely as a mechanism for permitting a solution to be achieved more quickly, (i.e., through the utilization of a computer for performing calculations). For example, these methods save time for the user by removing manual input, which results in increasing efficiency of machine use. Therefore, such processes increase data quality, which in turn improves success rate of faxes and emails sent. Moreover, costs savings for the organization may be realized due to the machine not being required to be connected to the network. Accordingly, data integrity and security is not compromised, resulting in overall better customer experience.

As would be understood by one ordinarily skilled in the art, the processes described herein cannot be performed by human alone (or one operating with a pen and a pad of paper) and instead such processes can only be performed by a machine. Specifically, processes such as automated scanning of USB files, character recognition, electronic transmission of data over networks, etc., require the utilization of different specialized machines. Therefore, for example, the establishment of designated address lists from multiple varied sources, which is performed by the devices herein, cannot be performed manually (because machines are required to scan memory devices and coordinate multiple address lists) and such devices are integral with the processes performed by methods herein. Further, such machine-only processes are not mere “post-solution activity” because the automated analysis of email addresses and fax phone numbers by a processor is integral with the steps of the processes described herein. Similarly, the electronic transmissions utilize special-purpose equipment (telecommunications equipment, routers, switches, etc.) that is distinct from a general-purpose processor. In other words, these various machines are integral with the methods herein because the methods cannot be performed without the machines (and cannot be performed by humans alone).

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further device and method herein, an article of manufacture is provided that includes a tangible computer readable medium having computer readable instructions embodied therein for performing the steps of the computer implemented methods, including, but not limited to, the methods illustrated in FIGS. 3A and 3B. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIGS. 3A and 3B.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In case of implementing the systems and methods herein by software and/or firmware, a program constituting the software may be installed into a computer with dedicated hardware, from a storage medium or a network, and the computer is capable of performing various functions if with various programs installed therein.

In the case where the above-described series of processing is implemented with software, the program that constitutes the software may be installed from a network such as the Internet or a storage medium such as the removable medium. Examples of a removable medium include a magnetic disk (including a floppy disk), an optical disk (including a Compact Disk-Read Only Memory (CD-ROM) and a Digital Versatile Disk (DVD)), a magneto-optical disk (including a Mini-Disk (MD) (registered trademark)), and a semiconductor memory. Alternatively, the storage medium may be the ROM, a hard disk contained in the storage section of the disk units, or the like, which has the program stored therein and is distributed to the user together with the device that contains them.

As will be appreciated by one skilled in the art, aspects of the systems and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read Only Memory (ROM), an Erasable Programmable Read Only Memory (EPROM or Flash memory), an optical fiber, a magnetic storage device, a portable compact disc Read Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various systems and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well known by those ordinarily skilled in the art and are discussed in, for example, U.S. Pat. No. 6,032,004, the complete disclosure of which is fully incorporated herein by reference. Such details are not described in detail herein to keep this disclosure focused on the salient features presented. The systems and methods herein can encompass devices that print in color, monochrome, or handle color or monochrome image data. All foregoing systems and methods are specifically applicable to electrostatographic and/or xerographic machines and/or processes.

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein, are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various systems and methods of the present disclosure have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method, comprising:
obtaining a physical copy of a document for transmission;
receiving selection for said transmission to be by one of fax or email;
prompting selection of a source for a recipient's address for said transmission, said recipient's address comprising a fax number or email address based on said transmission being by fax or by email;
upon selection of said source for said recipient's address being a portable data storage device, automatically searching said portable data storage device using a processor that recognizes text files and displaying a list of text files containing addresses;
receiving selection of files containing designated addresses for said transmission based on said transmission being by fax or by email;
scanning said physical copy of said document; and
transmitting said document to said designated addresses.

2. The method according to claim 1, further comprising:
creating a list of said designated addresses.

3. The method according to claim 2, further comprising:
saving said list of said designated addresses.

4. The method according to claim 1, further comprising:
reading the contents of selected files on said portable data storage device, said selected files containing designated addresses for said transmission;
automatically building an address list from the contents of said files; and
generating a display corresponding to a list of destination addresses.

5. The method according to claim 4, said automatically building an address list from the contents of said files further comprising:
parsing information of said recipient's address based on said transmission being by fax or by email.

6. The method according to claim 4, further comprising:
receiving selection of said designated addresses for said transmission based on said destination list of addresses.

7. The method according to claim 1, further comprising:
generating a display corresponding to workflows available for said transmission of said document.

8. The method according to claim 7, further comprising:
based on receiving selection of a selected workflow, generating a display corresponding to available address input options for said transmission of said document.

9. A method, comprising:
obtaining a physical copy of a document for transmission into a document rendering device;
said document rendering device generating a display corresponding to workflows available for transmission of said document, said workflows comprising transmission of said document by email and transmission by fax;
receiving selection of a selected workflow for said transmission of said document;
based on receiving selection of said selected workflow, said document rendering device generating a display corresponding to available address input options for said transmission of said document;
receiving a portable data storage device into said document rendering device, said portable data storage device comprising at least one electronic document containing an address list, said address list comprising at least one of email addresses and fax numbers;
said document rendering device searching said portable data storage device and displaying file names of electronic documents containing address lists found on said portable data storage device, for said selected workflow being transmission by email said document rendering device displaying only file names of electronic documents containing email addresses, and for said selected workflow being transmission by fax said document rendering device displaying only file names of electronic documents containing fax numbers;
receiving selection by name of particular files containing said address lists;
said document rendering device reading the contents of said particular files and displaying address lists from said particular files;
receiving selection of addresses from said address lists for transmission of said document;
creating a destination list comprising addresses selected for transmission;
saving said destination list comprising said addresses;
said document rendering device scanning said physical copy of said document; and
said document rendering device transmitting said document to said addresses on said destination list based on said selected workflow.

10. The method according to claim 9, said document rendering device searching said portable data storage device and displaying file names of electronic documents containing address lists found on said portable data storage device, further comprising:
identifying email addresses in said files by detecting an ‘@’ character within a text string in said file;
identifying fax numbers by detecting a series of numerals within said text string;
automatically building an address list from the contents of said files, said address list comprising only email addresses for said workflow comprising document transmission by email, and said address list comprising only fax numbers for said workflow comprising document transmission by fax; and
generating a display corresponding to a destination list of addresses.

11. The method according to claim 10, said display corresponding to said destination list of addresses comprising one of:
only email addresses for said transmission being by email, and only fax numbers for said transmission being by fax.

12. The method according to claim 10, said automatically building an address list from the contents of said files further comprising:
parsing information of said destination list based on said transmission being by fax or by email.

13. The method according to claim 9, said portable data storage device comprising a USB memory device.

14. A multifunction device comprising:
a control system comprising at least one processor in data communication with a memory;
a local user interface connected to said control system; and
a port, a portable data storage device being connected to said port,
said local user interface providing user selection of a selected one of mutually exclusive operations under control of said control system, said mutually exclusive operations comprising document delivery workflows comprising transmission of a selected document by email and transmission of said selected document by fax,
said local user interface providing user selection of a source for a document recipient's address according to one of said document delivery workflows,
upon selection of said source for said document recipient's address being said portable data storage device, said processor scanning said portable data storage device and displaying file names of files containing addresses on said local user interface under control of said control system, for a document delivery workflow being transmission by email said processor displaying only file names containing email addresses, and for a document delivery workflow being transmission by fax said processor displaying only file names containing fax numbers,
said local user interface receiving selection of a designated recipient's address according to said one of said document delivery workflows, and
said processor saving said designated recipient's address in said memory.

15. The multifunction device according to claim 14, said portable data storage device comprising a USB memory device.

16. The multifunction device according to claim 14, further comprising:
a scanner receiving said selected document for transmission,
said control system scanning said selected document using said scanner, and
said control system transmitting said selected document to each said designated recipient's address.

17. The multifunction device according to claim 14, said local user interface generating a display corresponding to said mutually exclusive operations; and
based on receiving selection of a selected document delivery workflow, said local user interface generating a display corresponding to available address input options for transmission of said selected document according to said selected document delivery workflow.

18. The multifunction device according to claim 17, said display corresponding to available address input options for said transmission of said selected document comprising one of:
only email addresses for said transmission being by email, and only fax numbers for said transmission being by fax.

19. The multifunction device according to claim 14, said processor searching said portable data storage device and displaying files containing addresses on said local user interface under control of said control system further comprising:
reading the contents of selected files on said portable data storage device;
identifying email addresses in said file by detecting an ‘@’ character within a text string in said file;
identifying fax numbers by detecting a series of numerals within said text string;
automatically building an address list from the contents of said files, said address list comprising one of only email addresses for said workflow comprising document transmission by email, and only fax numbers for said workflow comprising document transmission by fax; and
generating a display corresponding to a destination list of addresses.

20. The multifunction device according to claim 19, said automatically building an address list from the contents of said files further comprising:
parsing information of said recipient's address based on transmitting a selected document by fax or by email.
